(19) United States
(12) Patent Application Publication
(10) Pub. No.: US 2005/0185200 A1
(43) Pub. Date: Aug. 25, 2005

(54) Systems, methods, and computer program products for converting between color gamuts associated with different image processing devices

(75) Inventor: Nathan H. Tobol, Camarillo, CA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: ZIH Corp

(21) Appl. No.: 10/845,923

(22) Filed: May 14, 2004

Related U.S. Application Data
(60) Provisional application No. 60/470,732, filed on May 15, 2003.

(51) Int. Cl. H04N 1/60

(52) U.S. Cl. 358/1.9; 358/518; 358/521

(57) ABSTRACT

The present invention provides systems, methods, and computer program products for performing color gamut mapping between different color gamuts on a pixel basis. A set of desired parameters is initially defined representing the desired color gamut transformation to which the color values of the pixel are to be mapped. The parameters describe the best-fit lines for the portions of the curve for the gamut transform to which the specific parameters are applied. The present invention next maps the color values used for the pixel in the first color gamut and the color values used for the pixel in the second gamut to the parameters of the transform. The present invention performs mapping by isolating portions of a curve and approximating those portions of the curve with a best straight-line fit. This method of mapping from one color gamut to another color gamut is less computationally intensive than conventional methods.

### CROSS-REFERENCE TO RELATED APPLICATIONS

The present application claims priority from U.S. Provisional Patent Application Ser. No. 60/470,732, filed May 15, 2003, and entitled A NOVEL TECHNIQUE FOR COLOR GAMUT CORRECTION, the contents of which are incorporated herein by reference.

### BACKGROUND OF THE INVENTION

1. Field of the Invention

The present invention provides systems, methods, and computer program products for performing color management, and more particularly for performing color gamut conversion to improve image quality when images are printed or displayed on different imaging devices.

2. Description of Related Art

The perception of color is created by electromagnetic energy that exists in the form of wavelengths. In this regard, the visible spectrum is the range of light that can be seen with the unaided eye (See FIG. 1). Wavelengths above the visible spectrum are infrared (heat). The wavelengths below the visible spectrum include ultraviolet, x-rays and gamma rays. As illustrated, the human eye can perceive electromagnetic energy having wavelengths in the 380-780 nanometer range as color. The human eye has an effective color range that runs from violet to red.

Importantly, there are wide variety of devices, such as cameras and scanner, used to capture what the human eye is viewing and a wide variety of devices, such as monitors and printers, for displaying the captured images to a user. Unfortunately, there is a rather large difference between the visible spectrum perceived by the human eye and the colors that can be captured and reproduced on a computer screen and/or printed. The total number of colors that a device can produce is called its color gamut. FIG. 2 is a general illustration 10 of the color gamuts for the human eye 12 as compared to a typical monitor 14, typical film 16, and typical printer 18. As illustrated, the visible spectrum 12 associated with the human eye is larger than the color gamut of a color monitor 14, which in turn is larger than what can be reproduced by a color printer 18. In short, all colors viewable by the human eye of an image currently cannot be captured, displayed, or printed. Furthermore, some colors that are viewable to a user via a monitor are not always printable, as illustrated in the differences in the color gamut 14 for a monitor and the color gamut 18 for a printer. For this reason, color management systems have been developed to convert or map colors from one gamut to another gamut for image processing.

For example, FIG. 3 illustrates a general color management system 20. The system typically includes a PC or other general processor 22 connected to an image capture device, such as a camera 24 and/or scanner 26. The processor is also typically connected to a monitor 28 for displaying the captured image to a user. Further, the processor 22 is typically connected to a printer 30 for printing out the images. The processor is also usually connected to a storage device 32 containing stored images 34. Linking each of these devices 28-34 to the processor 22 are typically color gamut converters 36a-36e. The color gamut converters can be implemented in either hardware or software. In the case of software, the converter software is typically executed by the processor 22 in the form of a program or driver file. With reference to FIG. 2, the color gamut converter is used to convert between the various color gamuts when an image is to be provided to another device, such as from a monitor to a printer. Specifically, as illustrated in FIG. 3, each device has associated therewith a profile 38a-38e. This profile defines various values used by the color gamut converter to convert images into the proper format.

In addition to having different color gamuts, printers use a different technique for color reproduction than do cameras, scanners, and monitors. Specifically, as illustrated in FIG. 4A, cameras, scanners, and monitors use an additive color reproduction principle. The primary colors of additive color reproduction are red 42, blue 44, and green 46. When these three primary colors of light are projected on one another in equal parts they produce white light 48, while the absence of RGB colored light results in black. Other colors can be created by varying the intensities of red, blue, and green.

FIG. 4B illustrates the subtractive color process used by printers. Subtractive colors are produced when white light falls on a colored surface and is partially reflected. The reflected light reaching the human eye produces the sensation of color. Subtractive color is based on the three colors cyan (C) 50, magenta (M) 52, and yellow (Y) 54. Other colors are produced by varying the mixture of these primary colors. When these three colors are mixed together at 100% they produce black 56, while the absence of cyan, magenta, and yellow pigments result in white. In this regard, impurities in the inks used and equipment calibration and drift can make it difficult to obtain a pure black color. As such, many printers use a fourth color black (K). For example, for thermal printers there are typically available either CMY ribbons having individual panels of cyan, magenta, and yellow or CMYK ribbons having an added black color panel.

As illustrated in FIG. 3, the camera 24, scanner 26, and monitor 28 all use RGB color representations, while the printer uses a CMY color representation. In this regard, the color gamut converter 36 must convert images from an additive color scheme to a subtractive color scheme when printing images.

Color management schemes for converting between different color gamuts involve conversion of color tone and hue, saturation, and value (HSV) of each individual pixel in an image. In this regard, tone is the lightness or darkness value of an image. Color is what is seen, and tone is what gives color its depth and form. When an image is converted from the color gamut of one device to another device having a smaller color gamut of lesser tonal range, tonal steps are compressed; meaning that the image has fewer tonal steps and is actually losing values of tone. All colors and tones have a hue, saturation, and value (HSV). Hue is the color being described, such as yellow, purple, or green. Saturation, also referred to as chroma, is the intensity or purity of the color, and value is the relative lightness or darkness of the color.

As illustrated in FIG. 3, in most color management schemes, color gamuts are mapped from device dependent color schemes, such as RGB and CMY schemes, to device independent schemes. Device independent schemes have been developed by CIE (Commission Internationale de L'Éclairage), such as CIE L*a*b and CIE L*u*v. Specifically, as illustrated in FIG. 5A, the human eye comprises three types of cones, red, green, and blue (R, G, and B), which are designated by the Greek letters beta β, gamma γ and rho ρ. As illustrated in FIG. 5B, CIE has established a set of imaginary red, blue, and green primary color curves that, when combined, cover the full gamut of human color vision. The curves are referred to as the color matching functions and are designated as \overline{x}, \overline{y}, and \overline{z}, as they are normalized values. The color matching functions are used to derive the XYZ tristimulus values, which uniquely define an object's colorimetry. These tristimulus values XYZ are important because they form the basis of the CIE chromaticity diagram. (See FIG. 6). The tristimulus values can be mapped into two components: a chromaticity value (x, z) and a luminance value (Y′), which are used to map from one color gamut to another color gamut.

In this regard, there are a wide variety of techniques for mapping colors from one gamut to another. Unfortunately, however, most, if not all, of these techniques are processor intensive. The time required to make such conversions can cause significant delays in processing images for display on a monitor or printing of an image. In this regard, provided below is an example of conventional method for color gamut mapping.

FIG. 7 illustrates the steps performed on each pixel of an image. Briefly, they are:

1. Weight the spectrum with three response curves and integrate these three functions to get XYZ tristimulus values. (See block 102).

2. Map the XYZ values into two parts: a chromaticity value (x, z) and a luminance value (Y′). (See block 104).

3. Tone map the image by applying a non-linear function to each Y′. (See block 106).

4. Convert each tone mapped (x, z)Y′ value to RGB via a matrix multiply. (See block 108).

5. Map the color gamut to the monitor gamut. (See block 110).

6. Repeat for each pixel. (See blocks 112 and 114).

7. Display Image. (See block 116).

With regard to step 1, as an initial step, XYZ tristimulus values are first determined by weighting the spectrum with three response curves and integrate the three functions. This can be performed by either an analytical or numerical integration of the spectrum, typically the later. The typical formulas applied are:
Y=683∫\overline{y}(λ)L(λ)dλ
X=683∫\overline{x}(λ)L(λ)dλ
Z=683∫\overline{z}(λ)L(λ)dλ
The response curves for these integrals, \overline{x}, \overline{y}, \overline{z} are matched to the response curves of the human eye. The Y value is the brightness of a color, and as such, the \overline{y} response is considered roughly the sum of the long and medium cone response curves. (See block 100).

Next, step 2, the X, Y, Z values are normalized to x, y, and z, such that x+y+z=1 and tone map Y into Y′. The XYZ values are normalized to x, y, and z, where, x=X/(X+Y+Z), y=Y/(X+Y+Z), and z=Z/(X+Y+Z). This normalization (division by X+Y+Z) removes the brightness so that only two coordinates, x and y, are needed to define chromaticity. Since Y is closely related to luminance, colors are sometimes expressed as xyY tristimulus values. (See block 104).

With regard to Step 3, tone mapping of the Y scales the RGB values of an image, which might be too bright or too dark to be displayed. (See block 106). This is done by finding the tonal range of the output image, which is based on the image's “key value” or “neutral value.” The log-average luminance is calculated which is used as the key of the image. The image is then scaled using this log-average and alpha. Alpha determines the brightness or darkness of the image. A tone mapping operator, such as Reinhard, Stark, Shirley, and Ferwarda is applied:

$${Y}^{′} = \frac{kY}{1 + kY}$$

The following formula is typically applied to convert x, y to the range of [0-1]:

$${X}^{′} = \frac{{xY}^{′}}{y}$$

$${Z}^{′} = \frac{( 1 - x - y ) {Y}^{′}}{y}$$

With regard to Step 4 and 5 (see blocks 108 and 110), the RGB triples are derived from the XYZ values via a matrix operation, such as:

$$[ \begin{matrix}R \\ G \\ B\end{matrix} ] = [ \begin{matrix}2.5623 & - 1.1661 & - 0.3962 \\ - 1.0215 & 1.9778 & 0.0437 \\ 0.0752 & - 0.2562 & 1.1810\end{matrix} ] [ \begin{matrix}X \\ Y \\ Z\end{matrix} ]$$

As can be seen, this transformation is processor intensive and can require an unacceptable time for processing. As such, systems and methods are needed that provide color gamut mapping with reduced processing and time delay.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an illustration of the visible spectrum of colors that are detectable by the human eye.

FIG. 2 is an illustration of the color gamuts for the human eye, a monitor, film, and printer transposed on the CIE xyz color space.

FIG. 3 is a diagram illustrating various peripherals connected via central processor, where each of the peripherals uses a different color gamut.

FIGS. 4A and 4B respectively illustrate additive and subtractive color processes.

FIG. 5A is an illustration of the color spectrum sensitivity of the human eye.

FIG. 5B is an illustration of the CIE color matching functions to match the color spectrum sensitivity of the human eye.

FIG. 6 is an illustration of the CIE chromaticity diagram.

FIG. 7 is an operational diagram illustrating a conventional procedure for color gamut conversion.

FIG. 8 is an operational diagram illustrating the steps for mapping the pixels of an image from one color gamut to another according to one embodiment of the present invention.

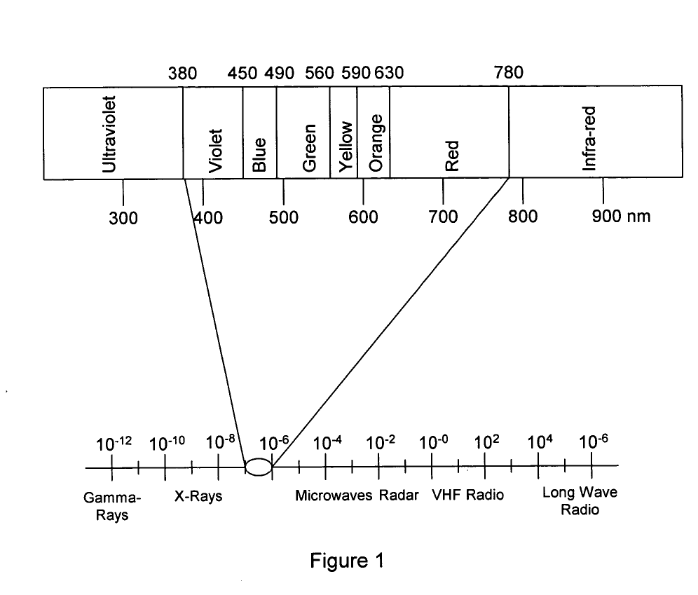

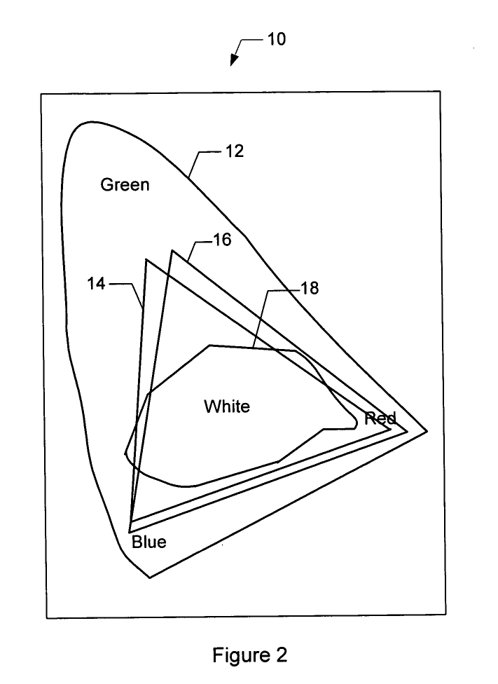

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention provides systems, methods, and computer program products for performing color gamut mapping. Importantly, the systems, methods, and computer program products are less processing and time intensive. Instead of performing complex conversion calculations, the systems, methods, and computer program products of the present invention performs a set of simplified mathematical steps to map the colors of the pixel from one color gamut to another color gamut.

Specifically, in the present invention a set of desired parameters is defined representing the desired color gamut transformation to which the colors of the pixel are to be mapped. The transforms are typically in form of curves. For example, if the peripheral is a printer, a desired set of transforms representing the three colors cyan, magenta, and yellow used for printing an image is defined. These transforms are determined based in part on factors relating to the printer and the media used for printing. For example, the color gamut of a thermal printer is affected by the particular characteristics of the print head and the particular characteristics of the print ribbon. The parameters describe the best fit lines for the portions of the curve for the gamut transform to which the specific parameters are applied.

After the parameters of the transforms have been defined, the systems, methods, and computer program products of the present invention next fit or map the colors used for the pixel, (e.g., red, green, and blue (RGB)), and the colors used to print the pixel, (e.g., cyan, magenta, and yellow (CMY)), to the parameters, such that the RGB values and CMY values are mapped to the color gamut of the printer. In this regard, fitting the color values to the parameters of the transforms representing the color gamut of the printer can be computationally intensive. Even fitting the curve/transform using a quadratic best fit can consume an unacceptable amount of computing time. For this reason, the systems, methods, and computer program products of the present invention perform mapping by isolating portions of a curve and approximating those portions of the curve with a best straight line fit. This method is far less computationally intensive than the conventional methods and yields results that are of very high quality.

As an initial note, the systems, methods, and computer program products of the present invention may be implemented in any system requiring color gamut mapping from the color gamut of one device to the color gamut of another device, or for application that require changing the color gamut to improve image quality. In typical embodiments, the systems, methods, and computer program products are used to convert individual pixels of image from an RGB gamut associated either with image itself or the monitor displaying the image into a CMY gamut associated with a printer, such as thermal dye printer, laser printer, ink jet printer, etc. However, it is noted that the systems, methods, and computer program products of the present invention are not limited to this embodiment. For example, the systems, methods, and computer program products may be used to map from the color gamut associated with a camera or scanner to the color gamut of a monitor.

Further, the below example of the operation of the systems, methods, and computer program products of the present invention illustrate conversion of RGB values in a first color gamut to CMY values in a second color example. It must be understood that this is only one example. The systems, methods, and computer program products of the present invention may be used to map between two color gamuts no matter what type of color values are used to define the colors in each gamut. For example, where both devices are RGB devices, such as a scanner and a monitor, the systems, methods, and computer program products would map the RGB colors associated with the scanner in the scanner's gamut to the RGB colors associated with the monitor in the monitor's gamut. In short, the present invention can be used for RGB to RGB mapping, CMY to CMY mapping, RGB to CMY, CMY to RGB, etc. The present invention is not limited to RGB and CMY representations of color either. The present invention can be used to map from one color gamut to another no matter what type of values are used to represent the colors in each gamut.

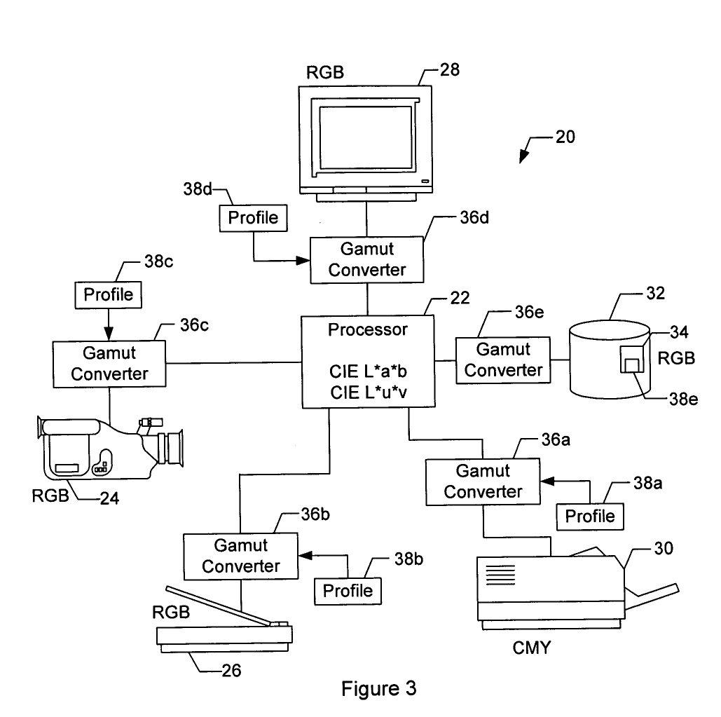

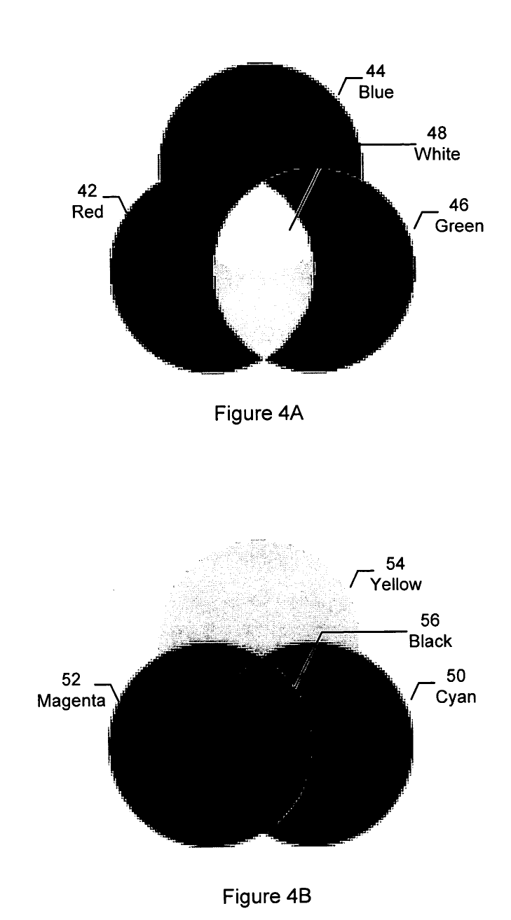

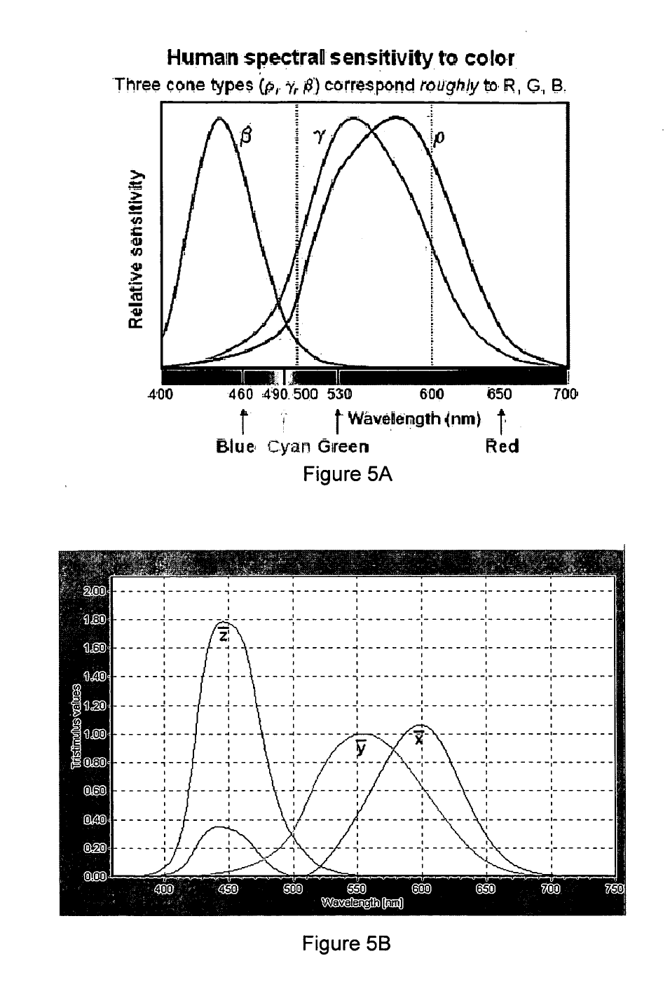

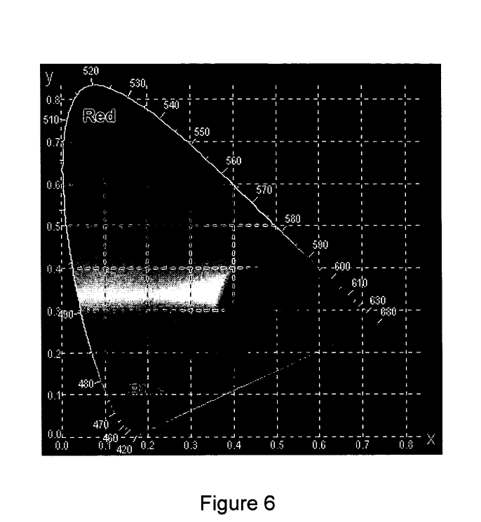

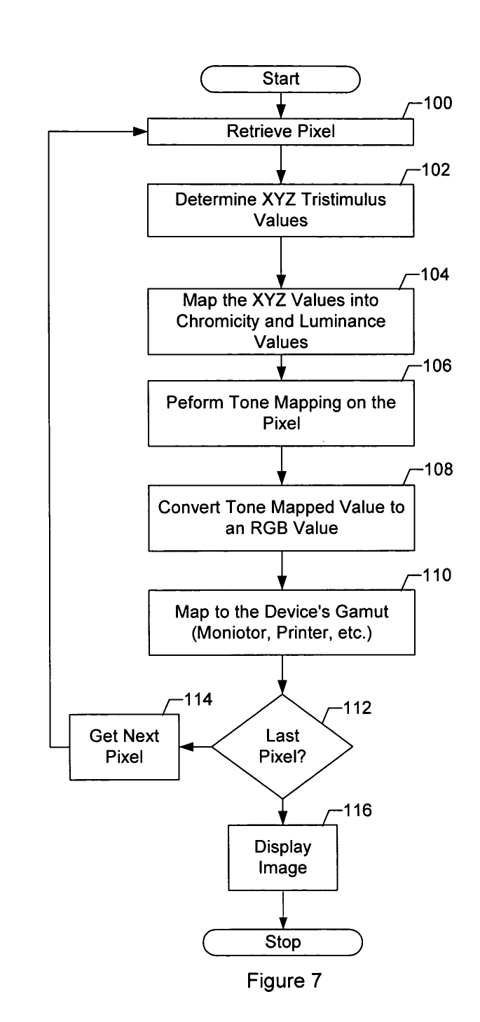

The systems, methods, and computer program products of the present invention may be implemented in any system. For purposed of explanation, the below discussion is given in the context of the system illustrated at FIG. 3. In the below explanation, an image is mapped one pixel at a time into the color gamut of the printer 30 for printing. With reference to FIG. 3, as general matter, the processor 22 typically receives an image either from the storage device 32 for printing or an image that is currently displayed on the monitor 28. The color gamut converter 36a then operates in conjunction with the printer driver associated with the printer to convert the image into the proper color gamut for printing on the printer. Provided below is a brief summary of the steps performed by the systems, methods, and computer program products of the present invention to perform the color gamut mapping:

Step 1. A set of parameters representing the desired color gamut transformation is defined.

Step 2. The RGB gray level for the pixel is determined.

Step 3. The RGB gray level value is subtracted from each of the three components (R, G, and B) of the pixel.

Step 4. The strength of the pixel is determined.

Step 5. The RGB values are mapped to the defined parameters of the transforms.

Step 6. The RGB gray level value is added back into each of the three components (R, G, and B) of the mapped values of the pixel.

Step 7. The mapped RGB values are converted to initial CMY values.

Step 8. The CMY gray level for the pixel is determined.

Step 9. The CMY gray level value is subtracted from each of the three components (C, M, and Y) of the pixel.

Step 10. The initial CMY values are mapped to the defined parameters of the transform.

Step 11. A portion of the mapped CMY value, determined by the strength of the pixel, is combined with a portion of the initial CMY value.

Step 12. The CMY gray level value is added back into each of the three mapped components (C, M, and Y) of the pixel.

Step 13. If the pixel is to be displayed or saved in a file, it is converted back to RGB (if it is to be printed, the CMY value is typically what is required so this step is not needed).

With regard to step 1, a set of parameters is defined for the desired gamut transformation. These parameters describe the best fit lines for the portions of the curve for the gamut transform to which the specific parameters are applied. These curves may either represent a maximum color gamut of the printer or they may represent a desired color gamut. The curves are selected by evaluating the various parameters of the printer, including the characteristics of the print head and media used in the printer. For example, where the printer is a thermal dye printer, the curves are based in part of the characteristics of the print head and the dye ribbon used. If the printer, is an ink jet printer, the curves would be based in part on the print head and the inks used for printing. The curves represent the different colors used generate the gamut of colors in the printer, (e.g., the CMY colors).

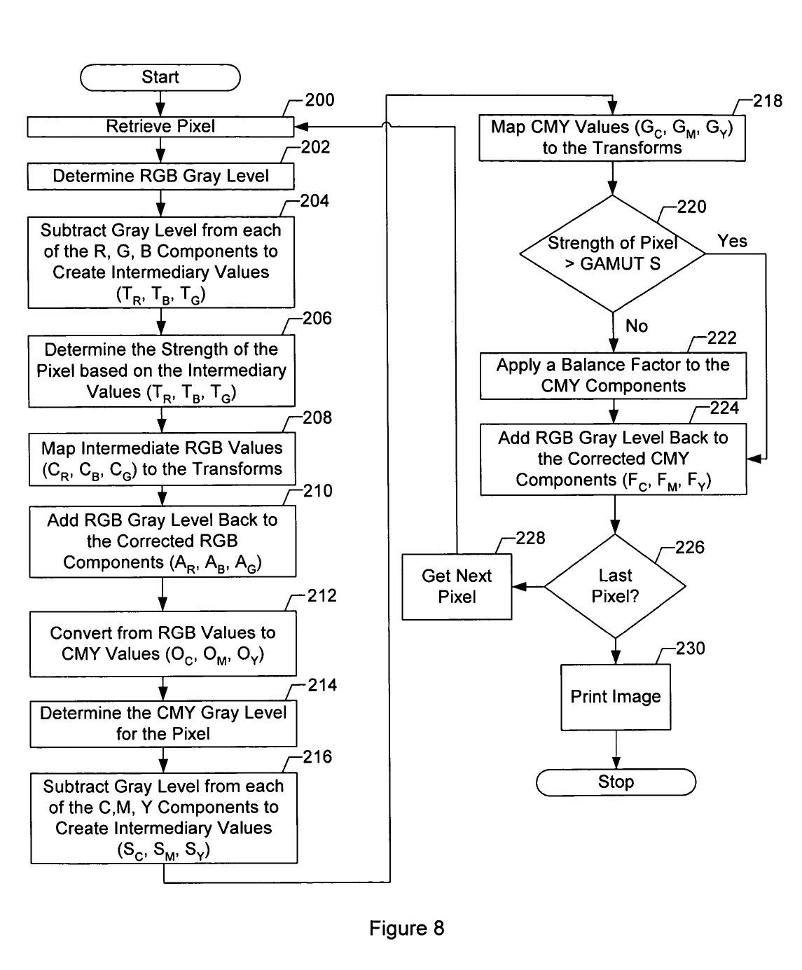

With reference to FIG. 8, after the parameters of the transforms have been defined, the systems, methods, and computer program products of the present invention, via a processor, initially receives the RGB value for a pixel. See block 200. These RGB values will be mapped to the defined parameters of step 1. At step 2, the processor will typically remove the gray level from each of the RGB values to isolate a portion of the curve. This is an optional step; if the desired curve is linear enough, it may not be required. To perform this step, the processor initially determines the RGB gray level for the pixel. (See block 202). In this regard, input pixels are typically described in terms of the additive colors Red, Blue, and Green:
Pᵢ=[I_{R}, I_{B}, I_{G}]
where I_{R}, I_{B}, I_{G} are each the range of 0 to (Iₘₐₓ−1). RGB gray level is calculated as:
RGBgray=min(min(I_{R}, I_{B}), I_{G})
As illustrated in this equation, the gray level is taken to be the minimum value of the RGB colors. For example, if the RGB colors had the values R=150, G=75, and B=50, the gray level value is 50.

At step 3, after the gray level is calculated, it is subtracted from each of the three R, G, and B components of the pixel to create intermediary RGB values, T_{R}, T_{B}, T_{G}. (See block 204).
T_{R}=I_{R}−RGBgray
T_{B}=I_{B}−RGBgray
T_{G}=I_{G}−RGBgray
Following the above example, where R=150, G=75, and B=50, the intermediate values would be:
T_{R}=150−50=100
T_{B}=50−50=0
T_{G}=75−50=25

At step 4, after the gray level is subtracted, the strength of the pixel is determined from the intermediary RGB values, T_{R}, T_{B}, T_{G}. (See block 206).
strength=max(max(T_{R}, T_{B}), T_{G})/Iₘₐₓ
The strength of the pixel is used later in an optional step to balance the mapped colors. While the RGB values are used to determine the strength of the pixel, CMY values associated with the pixel, determined later, could be used to assess the strength of the pixel.

At step 5, the intermediary RGB values, T_{R}, T_{B}, T_{G}, are next mapped to the defined parameters of the transforms for the printer. (See block 208). The intermediary RGB values are mapped to the parameters based on the amount of contribution that each color R, G, and B makes on all mapped colors. This is a set of weighting/correction factors based on the color R, G, and B content of the pixel. The typical range of each factor is −-0.2 to 1.2 (but values outside of this range are not precluded):

GAMUT_RR—Contribution that red value makes to mapped red

GAMUT_RG—Contribution that green value makes to mapped red

GAMUT_RB—Contribution that blue value makes to mapped red

GAMUT_GR—Contribution that green value makes to mapped green

GAMUT_GG—Contribution that green value makes to mapped green

GAMUT_GB—Contribution that blue value makes to mapped green

GAMUT_BR—Contribution that red value makes to mapped blue

GAMUT_BG—Contribution that green value makes to mapped blue

GAMUT_BB—Contribution that blue value makes to mapped blue

The correction factors are then applied to calculate mapped RGB values C_{R}, C_{G}, C_{B}:
C_{R}=+T_{R}*GAMUT_RR−T_{B}*GAMUT_RG−T_{G}*GAMUT_RB
C_{G}=−T_{R}*GAMUT_GR+T_{B}*GAMUT_GG−T_{G}*GAMUT_GB
C_{B}=−T_{R}*GAMUT_BR−T_{B}*GAMUT_BG+T_{G}*GAMUT_BB
As illustrated in the above equation, each mapped RGB value represents the amount that the associated color, (e.g., R), makes to the mapped color minus the amounts that the other two colors, (e.g., G and B) make to the mapped color. In this way each of the color components R, G, and B are individually mapped to the associated parameters of the transform for the color.

At step 6, after the RGB values have been mapped, the RGB gray level value is added back into each of the three components (R, G, B) of the pixel. (See block 210). This step is done only if the gray level was removed prior to mapping.
A_{R}=C_{R}+RGBgray
A_{G}=C_{G}+RGBgray
A_{B}=C_{B}+RGBgray

As is illustrated above, the present invention subtracts out the gray level thereby isolating the color values that need to be mapped and then the gray level is added back to the mapped color values. These steps at least removes one of the color values from the mapping process as the color have the lowest value of the three is taken as the gray level. In some instance, two of the colors are eliminated if they are both either the same low value or approximately the same value.

At step 7, after the RGB values have been mapped to the parameters of the transforms, it is next converted to CMY values O_{C}, O_{M}, O_{Y} for the printer. (See block 212). In short, the mapped RGB values are used to map the CMY values. This procedure is used to fit the CMY values to the parameters of the transforms. By mapping the RGB colors to the parameters of the transforms and then using the RGB mapped values to map the CMY values, complex fitting algorithms are avoided.

In instances where the RGB components A_{R}, A_{G}, A_{B} are each in the range of 0 to (Iₘₐₓ−1) and CMY values O_{C}, O_{M}, O_{Y} are each in the range of 0 to (Oₘₐₓ−1), the following formulas are the generic conversion between RGB and CMY:
O_{C}=(Aₘₐₓ−A_{R}−1)*Oₘₐₓ/Aₘₐₓ
O_{M}=(Aₘₐₓ−A_{G}−1)*Oₘₐₓ/Aₘₐₓ
O_{Y}=(Aₘₐₓ−A_{B}−1)*Oₘₐₓ/Aₘₐₓ
Since Oₘₐₓ=Iₘₐₓ, and both are equal to 256 for a typical 24-bit color image, these formulas reduce, in typical cases, to:
O_{C}=255−A_{R}
O_{M}=255−A_{G}
O_{Y}=255−A_{B}

At step 8, after the RGB mapped values are converted to CMY values, the processor may remove the gray level from the CMY values to reduce computations. Specifically, the processor determines the CMY gray level for the pixel as (see block 214):
CMYgray=min(min(O_{C},O_{M}),O_{Y})
which is the smallest value of the CMY components.

At step 9, the CMY gray level value is subtracted from each of the three components CMY of the pixel (see block 216):
S_{C}=O_{C}−CMYgray
S_{M}=O_{M}−CMYgray
S_{Y}=O_{Y}−CMYgray

At step 10, mapped CMY values are calculated. (See block 218). The CMY value is mapped to the transforms based on the amount of contribution that each C, M, and Y component makes on all mapped colors. These are weighting/correction factors based on the color C, M, and Y content of the pixel. The typical range of each factor is −0.2 to 1.2 (but values outside of this range are not precluded):

GAMUT_CC—Contribution that cyan value makes to mapped cyan

GAMUT_CM—Contribution that cyan makes to mapped cyan

GAMUT_CY—Contribution that yellow makes to mapped cyan

GAMUT_MC—Contribution that magenta makes to mapped magenta

GAMUT_MM—Contribution that green makes to mapped magenta

GAMUT_MY—Contribution that yellow makes to mapped magenta

GAMUT_YC—Contribution that cyan makes to mapped yellow

GAMUT_YM—Contribution that magenta makes to mapped yellow

GAMUT_YY—Contribution that yellow makes to mapped yellow

The weighting factors are applied as follows:
G_{c}=+S_{c}*GAMUT_CC−S_{M}*GAMUT_CM−S_{Y}*GAMUT_CY
G_{M}=−S_{c}*GAMUT_MC+S_{M}*GAMUT_MM−S_{Y}*GAMUT_MY
G_{Y}=−S_{c}*GAMUT_YC−S_{M}*GAMUT_YM+S_{Y}*GAMUT_YY

As illustrated in the above equation, each mapped CMY value represents the amount that the associated color, (e.g., C), makes to the mapped color minus the amounts that the other two colors, (e.g., M and Y) make to the mapped color. In this way each of the color components C, M, and Y are individually mapped to the associated transform for the color.

After the CMY values have been mapped to the transforms, the systems, methods, and computer program products of the present invention may balance or scale some of the pixels. This step is optional, but can be used to balance individual pixels to provide a desired print color. For example, as discussed at step 11, some of the pixels may be balanced based on their pixel strength. In one embodiment, a portion of the mapped CMY value, determined by the strength of the pixel, is combined with a portion of the unmapped CMY value. Specifically, the strength of the pixel is compared to a gamut dependent value GAMUT_S, (i.e., a threshold value). (See block 220). The color is determined to be not “strong” if the strength is less than a gamut dependent value GAMUT_S. If the color has a strength less than GAMUT_S, a balance factor is calculated and applied (see block 222). The balance value is a scaling factor for the CMY values. Typical values for the GAMUT_S value are 100 to 200 (but values outside of this range are not precluded).
b=(GAMUT_S−max(strength, GAMUT_S/2))/(GAMUT_S/2))
B_{C}=(1−b)*S_{C}+b*G_{C}
B_{M}=(1−b)*S_{M}+b*G_{M}
B_{Y}=(1−b)*S_{C}+b*G_{Y}
On the other hand, if the color has a strength value equal to or greater than the GAMUT_S value, the values (B_{C}, B_{M}, B_{Y}) are equal to the mapped values are:
B_{C}=G_{C}
B_{M}=G_{M}
B_{Y}=G_{Y}

The present invention may also provide a scaling factor to the color values of a pixel having a strength greater than the threshold value. Such a threshold would be based on the particular characteristic desired for stronger pixels.

At step 12, the CMY gray level value is added back into each of the three components C, M, and Y of the pixel to generate the final mapped CYM values (F_{C}, F_{M}, F_{Y}). (See block 224).
F_{C}=B_{C}−CMYgray
F_{M}=B_{M}−CMYgray
F_{Y}=B_{Y}−CMYgray

At step 13, the pixel is now in the correct form for printing. This process is continued for all pixels. (See blocks 226 and 228). After all pixels are processed, the image is printed. (See block 230). If the pixel is to be displayed or saved in a file, it is converted back to RGB. For example, if the colors of the first color gamut are in RGB and the colors for the second color gamut are also in RGB, the present invention performs the above steps and at the last step converts the CMY values to RGB values.

In addition to providing systems and methods, the present invention also provides computer program products for performing the color mapping. The computer program products have a computer readable storage medium having computer readable program code means embodied in the medium. In this regard, FIG. 8 is a flowchart and control flow illustration of methods, systems and program products according to the invention. It will be understood that each block or step of the block diagram, flowchart and control flow illustrations, and combinations of blocks in the block diagram, flowchart and control flow illustrations, can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for converting at least one pixel of an image from a first color gamut to a second color gamut, said method comprising:
receiving a set of red, green, blue values of a pixel, where the red, green, and blue values are in the first color gamut;
mapping the red, green, and blue values to a set of parameters that define transforms representing the second color gamut thereby forming a set of mapped red, green, and blue values for the pixel;
converting the set of mapped red, green, and blue values of the pixel to a set of cyan, magenta, and yellow values for the pixel; and
mapping the cyan, magenta, and yellow values to the set of parameters to define a set of mapped cyan, magenta, and yellow values for the pixel.

2. A method according to claim 1, wherein said step of mapping the red, green, and blue values comprises subtracting a gray level value associated with the pixel from the red, green, and blue values prior to mapping the red, green, and blue values.

3. A method according to claim 1, wherein said step of mapping the red, green, and blue values comprises:
subtracting a gray level value associated with the pixel from the red, green, and blue values to define a set of intermediary red, green, and blue values;
mapping the set of intermediary red, green, and blue values to the parameters of the transforms by applying a set of weighting factors to the intermediary red, green, and blue values; and thereafter
adding a gray level value to the mapped red, green, and blue values.

4. A method according to claim 3, wherein said mapping a set of intermediary red, green, and blue values comprises:
determining a set of weighting factors, where each weighting factor is based on the amount of contribution that each red, green, and blue color makes to the mapped red, green, and blue colors of the pixel; and
applying the set of weighting factors to the set of red, green, and blue values.

5. A method according to claim 4, wherein said mapping a set of red, green, and blue values to the parameters of the transforms comprises:
calculating a mapped red value by subtracting the contributions made to the color red by the green and blue colors from the contribution made by the red color;
calculating a mapped green value by subtracting the contributions made to the color green by the red and blue colors from the contribution made by the green color; and
calculating a mapped blue value by subtracting the contributions made to the color blue by the red and green colors from the contribution made by the blue color.

6. A method according to claim 1, wherein said step of mapping the cyan, magenta, and yellow values comprises subtracting a gray level value associated with the pixel from the cyan, magenta, and yellow values prior to mapping the cyan, magenta, and yellow values.

7. A method according to claim 1, wherein said step of mapping the cyan, magenta, and yellow values comprises:
subtracting a gray level value associated with the pixel from the cyan, magenta, and yellow values to create a set of intermediary cyan, magenta, and yellow values;
mapping the set of intermediary cyan, magenta, and yellow values by applying a set of weighting factors to the intermediary cyan, magenta, and yellow values; and thereafter
adding a gray level value to the mapped cyan, magenta, and yellow values.

8. A method according to claim 7, wherein said mapping a set of cyan, magenta, and yellow values to the parameters of the transforms comprises:
determining a set of weighting factors, where each weighting factor is based on the amount of contribution that each cyan, magenta, and yellow color makes to the pixel; and
applying the set of weighting factors to the set of cyan, magenta, and yellow values.

9. A method according to claim 8, wherein said determining a set of weighting factors for the cyan, magenta, and yellow values comprises determining the contribution that each cyan, magenta, and yellow value makes to the pixel.

10. A method according to claim 9, wherein said mapping a set of cyan, magenta, and yellow values to the parameters of the transforms comprises:
calculating a mapped cyan value by subtracting the contributions made to the color cyan in the pixel by the magenta and yellow colors from the contribution made by the cyan color;
calculating a mapped magenta value by subtracting the contributions made to the color magenta by the cyan and yellow colors from the contribution made by the magenta color; and
calculating a mapped yellow value by subtracting the contributions made to the color yellow by the cyan and magenta colors from the contribution made by the yellow color.

11. A method according to claim 1 further comprising the step of determining a strength value associated with the pixel.

12. A method according to claim 11 further comprising:
comparing the strength value of the pixel to a strength threshold value;
if the pixel strength is less than the threshold value, determining a portion of the mapped cyan, magenta, and yellow values based on the strength of the pixel; and
combining the portion of the mapped cyan, magenta, and yellow values with the original cyan, magenta, and yellow values.

13. A method according to claim 12, wherein if the strength value of the pixel is at least as great as the strength threshold value, said method comprising applying a scale factor to the mapped cyan, magenta, and yellow values.

14. A system for converting at least one pixel of an image from a first color gamut to a second color gamut, said system comprising a processor that:
receives a set of red, green, blue values of a pixel, where the red, green, and blue values are in the first color gamut;
maps the red, green, and blue values to a set of parameters that define transforms representing the second color gamut thereby forming a set of mapped red, green, and blue values for the pixel;
converts the set of mapped red, green, and blue values of the pixel to a set of cyan, magenta, and yellow values for the pixel; and
maps the cyan, magenta, and yellow values to the set of parameters to define a set of mapped cyan, magenta, and yellow values for the pixel.

15. A system according to claim 14, wherein when said processor maps the red, green, and blue values, said processor subtracts a gray level value associated with the pixel from the red, green, and blue values prior to mapping the red, green, and blue values.

16. A system according to claim 14, wherein when said processor maps the red, green, and blue values, said processor:
subtracts a gray level value associated with the pixel from the red, green, and blue values to define a set of intermediary red, green, and blue values;
maps the set of intermediary red, green, and blue values to the parameters of the transforms by applying a set of weighting factors to the intermediary red, green, and blue values; and thereafter
adds a gray level value to the mapped red, green, and blue values.

17. A system according to claim 16, wherein when said processor maps the red, green, and blue values, said processor:
determines a set of weighting factors, where each weighting factor is based on the amount of contribution that each red, green, and blue color makes to the mapped red, green, and blue colors of the pixel; and
applies the set of weighting factors to the set of red, green, and blue values.

18. A system according to claim 15, wherein when said processor maps the red, green, and blue values, said processor:
calculates a mapped red value by subtracting the contributions made to the color red by the green and blue colors from the contribution made by the red color;
calculates a mapped green value by subtracting the contributions made to the color green by the red and blue colors from the contribution made by the green color; and
calculates a mapped blue value by subtracting the contributions made to the color blue by the red and green colors from the contribution made by the blue color.

19. A system according to claim 14, wherein when said processor maps the cyan, magenta, and yellow values, said processor subtracts a gray level value associated with the pixel from the cyan, magenta, and yellow values prior to mapping the cyan, magenta, and yellow values.

20. A system according to claim 14, wherein when said processor maps the cyan, magenta, and yellow values, said processor:
subtracts a gray level value associated with the pixel from the cyan, magenta, and yellow values to create a set of intermediary cyan, magenta, and yellow values;
maps the set of intermediary cyan, magenta, and yellow values by applying a set of weighting factors to the intermediary cyan, magenta, and yellow values; and thereafter
adds a gray level value to the mapped cyan, magenta, and yellow values.

21. A system according to claim 20, wherein when said processor maps the cyan, magenta, and yellow values, said processor:
determines a set of weighting factors, where each weighting factor is based on the amount of contribution that each cyan, magenta, and yellow color makes to the pixel; and
applies the set of weighting factors to the set of cyan, magenta, and yellow values.

22. A system according to claim 21, wherein said when said processor determines a set of weighting factors for the cyan, magenta, and yellow values said process determines the contribution that each cyan, magenta, and yellow value makes to the pixel.

23. A system according to claim 22, wherein when said processor maps the cyan, magenta, and yellow values, said processor:
calculates a mapped cyan value by subtracting the contributions made to the color cyan in the pixel by the magenta and yellow colors from the contribution made by the cyan color;
calculates a mapped magenta value by subtracting the contributions made to the color magenta by the cyan and yellow colors from the contribution made by the magenta color; and
calculates a mapped yellow value by subtracting the contributions made to the color yellow by the cyan and magenta colors from the contribution made by the yellow color.

24. A system according to claim 14, wherein said processor further determines a strength value associated with the pixel.

25. A system according to claim 14, wherein said processor further:
compares the strength value of the pixel to a strength threshold value;
if the pixel strength is less than the threshold value, determines a portion of the mapped cyan, magenta, and yellow values based on the strength of the pixel; and
combines the portion of the mapped cyan, magenta, and yellow values with the original cyan, magenta, and yellow values.

26. A system according to claim 25, wherein if the strength value of the pixel is at least as great as the strength threshold value, said processor applies a scale factor to the mapped cyan, magenta, and yellow values.

27. A computer program product for converting at least one pixel of an image from a first color gamut to a second color gamut, said computer program product comprising:
a computer-readable storage medium having computer readable program code means embodied in said medium, said computer-readable program code means comprising:
first computer instruction means for receiving a set of red, green, blue values of a pixel, where the red, green, and blue values are in the first color gamut;
second computer instruction means for mapping the red, green, and blue values to a set of parameters defining transforms representing the second color gamut thereby forming a set of mapped red, green, and blue values for the pixel;
third computer instruction means for converting the set of mapped red, green, and blue values of the pixel to a set of cyan, magenta, and yellow values for the pixel; and
fourth computer instruction means for mapping the cyan, magenta, and yellow values to define a set of mapped cyan, magenta, and yellow values for the pixel.

28. A computer program product according to claim 27, wherein said second computer instruction means comprises means for subtracting a gray level value associated with the pixel from the red, green, and blue values prior to mapping the red, green, and blue values.

29. A computer program product according to claim 27, wherein said second computer instruction means comprises means for:
subtracting a gray level value associated with the pixel from the red, green, and blue values to define a set of intermediary red, green, and blue values;
mapping the set of intermediary red, green, and blue values to the parameters of the transforms by applying a set of weighting factors to the intermediary red, green, and blue values; and thereafter
adding a gray level value to the mapped red, green, and blue values.

30. A computer program product according to claim 29, wherein said means for mapping the set of intermediary red, green, and blue values comprises means for:
determining a set of weighting factors, where each weighting factor is based on the amount of contribution that each red, green, and blue color makes to the mapped red, green, and blue colors of the pixel; and
applying the set of weighting factors to the set of red, green, and blue values.

31. A computer program product according to claim 30, wherein said means for determining a set of mapped red, green, and blue values comprises means for:
calculating a mapped red value by subtracting the contributions made to the color red by the green and blue colors from the contribution made by the red color;
calculating a mapped green value by subtracting the contributions made to the color green by the red and blue colors from the contribution made by the green color; and
calculating a mapped blue value by subtracting the contributions made to the color blue by the red and green colors from the contribution made by the blue color.

32. A computer program product according to claim 27, wherein said fourth computer instruction means comprises means for subtracting a gray level value associated with the pixel from the cyan, magenta, and yellow values prior to mapping the cyan, magenta, and yellow values.

33. A computer program product according to claim 27, wherein said fourth computer instruction means comprises means for:
subtracting a gray level value associated with the pixel from the cyan, magenta, and yellow values to create a set of intermediary cyan, magenta, and yellow values;
mapping the set of intermediary cyan, magenta, and yellow values by applying a set of weighting factors to the intermediary cyan, magenta, and yellow values; and thereafter
adding a gray level value to the mapped cyan, magenta, and yellow values.

34. A computer program product according to claim 33, wherein said means for mapping the set of intermediary cyan, magenta, and yellow values comprises means for:
determining a set of weighting factors, where each weighting factor is based on the amount of contribution that each cyan, magenta, and yellow color makes to the pixel; and
applying the set of weighting factors to the set of cyan, magenta, and yellow values.

35. A computer program product according to claim 34, wherein said means for determining a set of weighting factors for the cyan, magenta, and yellow values comprises means for determining the contribution that each cyan, magenta, and yellow value makes to the pixel.

36. A computer program product according to claim 35, wherein said means for mapping a set of cyan, magenta, and yellow values comprises means for:
calculating a mapped cyan value by subtracting the contributions made to the color cyan in the pixel by the magenta and yellow colors from the contribution made by the cyan color;
calculating a mapped magenta value by subtracting the contributions made to the color magenta by the cyan and yellow colors from the contribution made by the magenta color; and
calculating a mapped yellow value by subtracting the contributions made to the color yellow by the cyan and magenta colors from the contribution made by the yellow color.

37. A computer program product according to claim 27 further comprising fifth computer instruction means for determining a strength value associated with the pixel.

38. A computer program product according to claim 37 further comprising means for scaling the mapped cyan, magenta, and yellow values, wherein said means comprises:
means for determining a strength value associated with the pixel; and
means for determining a portion of the corrected cyan, magenta, and yellow values based on the strength of the pixel; and
means for combining the portion of said corrected cyan, magenta, and yellow values with the uncorrected cyan, magenta, and yellow values.

39. A computer program product according to claim 37 further comprising means for applying a scale factor to the mapped cyan, magenta, and yellow values if the strength value of the pixel is at least as great as the strength threshold value.

40. A method for converting at least one pixel of an image from a first color gamut to a second color gamut, said method comprising:
receiving a first value that defines the color of a pixel in a first color gamut;
mapping the first value to a parameter of a transform that represents the second color gamut thereby forming a first mapped value;
converting the first mapped value to a second value that defines the color of the pixel in the second color gamut prior to mapping of the color to the parameter of the transform; and
mapping the second value to the parameter of the transform to thereby define a second mapped value for the pixel in the second color gamut.

41. A method according to claim 40, wherein said step of mapping the first value comprises:
subtracting a gray level value associated with the pixel from the first value to define an intermediary value;
mapping the intermediary value to the parameter of the transform by applying a weighting factor to create the first mapped value; and thereafter
adding a gray level value to the first mapped value.

42. A method according to claim 40, wherein said step of mapping the second value comprises:
subtracting a gray level value associated with the pixel from the second value to create an intermediary value;
mapping the intermediary value by applying a weighting factor to the intermediary value to create a second mapped value; and thereafter
adding a gray level value to the second mapped value.

43. A method according to claim 40 further comprising:
determining a strength value associated with the pixel;
comparing the strength value of the pixel to a strength threshold value;
if the pixel strength is less than the threshold value, determining a portion of the second mapped value based on the strength of the pixel; and
combining the portion of the second mapped value with the second value.

44. A method according to claim 40, wherein the first value that defines the color of a pixel in a first color gamut is a set of red, green, blue values, and the second value that defines the color of a pixel in a second color gamut is also a set of red, green, blue values.

45. A method according to claim 40, wherein the first value that defines the color of a pixel in a first color gamut is a set of red, green, blue values, and the second value that defines the color of a pixel in a second color gamut is a set of cyan, magenta, and yellow values.

46. A method according to claim 40, wherein the first value that defines the color of a pixel in a first color gamut is a set of cyan, magenta, and yellow values, and the second values that defines the color of a pixel in a second color gamut is a set of red, green, blue values.

47. A method according to claim 40, wherein the first value that defines the color of a pixel in a first color gamut is a set of cyan, magenta, and yellow values, and the second values that defines the color of a pixel in a second color gamut is also a set of cyan, magenta, and yellow values.

48. A system for converting at least one pixel of an image from a first color gamut to a second color gamut, said system comprising a processor that:
receives a first value that defines the color of a pixel in a first color gamut;
maps the first value to a parameter of a transform that represents the second color gamut thereby forming a first mapped value;
converts the first mapped value to a second value that defines the color of the pixel in the second color gamut prior to mapping of the color to the parameter of the transform; and
maps the second value to the parameter of the transform to thereby define a second mapped value for the pixel in the second color gamut.

49. A system according to claim 48, wherein when said processor maps the first value, said processor:
subtracts a gray level value associated with the pixel from the first value to define an intermediary value;
maps the intermediary value to the parameter of the transform by applying a weighting factor to create the first mapped value; and thereafter
adds a gray level value to the first mapped value.

50. A system according to claim 48, wherein when said processor maps the second value. said processor:
subtracts a gray level value associated with the pixel from the second value to create an intermediary value;
maps the intermediary value by applying a weighting factor to the intermediary value to create a second mapped value; and thereafter
adds a gray level value to the second mapped value.

51. A system according to claim 48 wherein said processor:
determines a strength value associated with the pixel;
compares the strength value of the pixel to a strength threshold value;
if the pixel strength is less than the threshold value, determines a portion of the second mapped value based on the strength of the pixel; and
combines the portion of the second mapped value with the second value.

52. A system according to claim 48, wherein the first value that defines the color of a pixel in a first color gamut is a set of red, green, blue values, and the second value that defines the color of a pixel in a second color gamut is also a set of red, green, blue values.

53. A system according to claim 48, wherein the first value that defines the color of a pixel in a first color gamut is a set of red, green, blue values, and the second value that defines the color of a pixel in a second color gamut is a set of cyan, magenta, and yellow values.

54. A system according to claim 48, wherein the first value that defines the color of a pixel in a first color gamut is a set of cyan, magenta, and yellow values, and the second values that defines the color of a pixel in a second color gamut is a set of red, green, blue values.

55. A system according to claim 48, wherein the first value that defines the color of a pixel in a first color gamut is a set of cyan, magenta, and yellow values, and the second values that defines the color of a pixel in a second color gamut is also a set of cyan, magenta, and yellow values.

56. A computer program product for converting at least one pixel of an image from a first color gamut to a second color gamut, said computer program product comprising:
a computer-readable storage medium having computer readable program code means embodied in said medium, said computer-readable program code means comprising:
first computer instruction means for receiving a first value that defines the color of a pixel in a first color gamut;
second computer instruction means for mapping the first value to a parameter of a transform that represents the second color gamut thereby forming a first mapped value;
third computer instruction means for converting the first mapped value to a second value that defines the color of the pixel in the second color gamut prior to mapping of the color to the parameter of the transform; and
fourth computer instruction means for mapping the second value to the parameter of the transform to thereby define a second mapped value for the pixel in the second color gamut.

57. A computer program product according to claim 56, wherein said second computer instruction means second computer instruction means comprises means for: subtracting a gray level value associated with the pixel from the first value to define an intermediary value;
mapping the intermediary value to the parameter of the transform by applying a weighting factor to create the first mapped value; and thereafter
adding a gray level value to the first mapped value.

58. A computer program product according to claim 56, wherein said fourth computer instruction means comprises means for:
subtracting a gray level value associated with the pixel from the second value to create an intermediary value;
mapping the intermediary value by applying a weighting factor to the intermediary value to create a second mapped value; and thereafter
adding a gray level value to the second mapped value.

59. A computer program product according to claim 56 further comprising fifth computer instruction means for:
determining a strength value associated with the pixel;
comparing the strength value of the pixel to a strength threshold value;
if the pixel strength is less than the threshold value, determining a portion of the second mapped value based on the strength of the pixel; and
combining the portion of the second mapped value with the second value.

60. A computer program product according to claim 56, wherein the first value that defines the color of a pixel in a first color gamut is a set of red, green, blue values, and the second value that defines the color of a pixel in a second color gamut is also a set of red, green, blue values.

61. A computer program product according to claim 56, wherein the first value that defines the color of a pixel in a first color gamut is a set of red, green, blue values, and the second value that defines the color of a pixel in a second color gamut is a set of cyan, magenta, and yellow values.

62. A computer program product according to claim 56, wherein the first value that defines the color of a pixel in a first color gamut is a set of cyan, magenta, and yellow values, and the second values that defines the color of a pixel in a second color gamut is a set of red, green, blue values.

63. A computer program product according to claim 56, wherein the first value that defines the color of a pixel in a first color gamut is a set of cyan, magenta, and yellow values, and the second values that defines the color of a pixel in a second color gamut is also a set of cyan, magenta, and yellow values.

64. A method for converting at least one pixel of an image from a first color gamut to a second color gamut, said method comprising:
receiving a first set of values that define the color of a pixel in a first color gamut;
mapping the first set of values to a set of transforms that represent the second color gamut thereby forming a first set of mapped values, said mapping step comprising:
subtracting a gray level value associated with the pixel from the first set of values to define a set of intermediary values;
mapping the intermediary values to the transforms to create a first set of mapped values; and
adding the gray level value to the first set of mapped values;
converting the first set of mapped values to a second set of values that define the color of the pixel in the second color gamut prior to mapping of the color to the transforms; and
mapping the second set of values to the set of transforms to thereby define a second set of mapped values for the pixel in the second color gamut.

65. A method for converting at least one pixel of an image from a first color gamut to a second color gamut, said method comprising:
receiving a first set of values that define the color of a pixel in a first color gamut;
mapping the first set of values to a set of transforms that represent the second color gamut thereby forming a first set of mapped values;
converting the first set of mapped values to a second set of values that define the color of the pixel in the second color gamut prior to mapping of the color to the transforms; and
mapping the second set of values to the set of transforms to thereby define a second set of mapped values for the pixel in the second color gamut, said mapping comprising:
subtracting a gray level value associated with the pixel from the second set of values to define a set of intermediary values;
mapping the intermediary values to the transforms to create a second set of mapped values; and
adding the gray level value to the second set of mapped values.

66. A method for converting at least one pixel of an image from a first color gamut to a second color gamut, said method comprising:
receiving a first set of values that define the color of a pixel in a first color gamut;
mapping the first set of values to a set of transforms that represent the second color gamut thereby forming a first set of mapped values, said step comprising applying a set of weighting factors to the first set of values, where each weighting factor is based on the amount of contribution that each value of the first set of values makes to the first set of mapped values of the pixel;
converting the first set of mapped values to a second set of values that define the color of the pixel in the second color gamut prior to mapping of the color to the transforms; and
mapping the second set of values to the set of transforms to thereby define a second set of mapped values for the pixel in the second color gamut.

67. A method for converting at least one pixel of an image from a first color gamut to a second color gamut, said method comprising:
receiving a first set of values that define the color of a pixel in a first color gamut;
mapping the first set of values to a set of transforms that represent the second color gamut thereby forming a first set of mapped values;
converting the first set of mapped values to a second set of values that define the color of the pixel in the second color gamut prior to mapping of the color to the transforms; and
mapping the second set of values to the set of transforms to thereby define a second set of mapped values for the pixel in the second color gamut, said step comprising applying a set of weighting factors to the second set of values, where each weighting factor is based on the amount of contribution that each value of the second set of values makes to the second set of mapped values of the pixel.
